(19) United States
(12) Patent Application Publication
(10) Pub. No.: US 2014/0319983 A1
(43) Pub. Date: Oct. 30, 2014

(54) DOOR ASSEMBLY AND CLOTHES TREATMENT APPARATUS HAVING THE SAME

(71) Applicant: SAMSUNG ELECTRONICS CO., LTD., Suwon-si (KR)

(72) Inventors: Nae Young PARK, Seoul (KR); Jin Woo SO, Seongnam-si (KR)

(73) Assignee: SAMSUNG ELECTRONICS CO., LTD., Suwon-si (KR)

(21) Appl. No.: 14/259,827

(22) Filed: Apr. 23, 2014

(30) Foreign Application Priority Data
Apr. 26, 2013 (KR) 10-2013-0046770

(51) Int. Cl. E06B 3/26; A47B 96/00; D06F 39/14; E06B 3/34

(52) U.S. Cl. CPC E06B 3/26; E06B 3/34; A47B 96/00; D06F 39/14
USPC 312/228; 49/67

(57) ABSTRACT

A clothes treatment apparatus including a cabinet having an opening, a drum placed within the cabinet to accommodate laundry therein, and a door assembly configured to open or close the opening. The door assembly includes a second module having a hollowed region and configured to be selectively open or closed in different directions, and a first module, at least a portion of which hermetically seals the hollowed region, the first module being configured not to interfere with opening/closing of the second module. Such an improved configuration of the door assembly ensures easy change in the opening/closing direction of a door.

### CROSS-REFERENCE TO RELATED APPLICATIONS

This application claims the priority benefit of Korean Patent Application No. 10-2013-0046770, filed on Apr. 26, 2013 in the Korean Intellectual Property Office, the disclosure of which is incorporated herein by reference

### BACKGROUND

1. Field

Example embodiments of the following disclosure relate to a door assembly having an improved configuration to easily change an opening/closing direction of a door and a clothes treatment apparatus having the same.

2. Description of the Related Art

In general, a washing machine is an apparatus that washes laundry via iterative rotation by introducing wash water and detergent into a tub and inserting the laundry into a drum inside the tub. Further, a drying machine is an apparatus that dries an object placed in a drum by forcibly blowing hot air into the drum.

These clothes treatment apparatuses include the drum rotatably installed therein, and the drum has an opening for insertion/removal of laundry. A door is provided to open or close the opening.

In the case in which the door is configured to open only in a given direction, opening/closing of the door may become inconvenient due to the wall of a room or other components according to a position of the clothes treatment apparatus placed in the room.

Moreover, even in the case in which the door is configured to open or close in multiple directions, change of an opening/closing direction of the door may inconveniently require disassembly and reassembly of a cabinet as well as the door.

### SUMMARY

Additional aspects and/or advantages will be set forth in part in the description which follows and, in part, will be apparent from the description, or may be learned by practice of the invention.

It is an aspect of the present disclosure to provide a door assembly to ensure easy change in the opening/closing direction of a door and a clothes treatment apparatus having the same.

Additional aspects of the invention will be set forth in part in the description which follows and, in part, will be obvious from the description, or may be learned by practice of the invention.

In accordance with an aspect of the invention, a clothes treatment apparatus includes a cabinet having an opening, a drum placed within the cabinet to accommodate laundry therein, the drum being rotated upon receiving rotation power from a drive source, a door assembly configured to open or close the opening for insertion/removal of the laundry into or from the drum, and a hinge coupling portion formed around the opening, to which one side of the door assembly is hingedly coupled, wherein the door assembly includes a first module having a door glass, and a second module separably coupled to the first module, the second module having a hinge unit fixed between a first body and a second body that respectively define a front surface and a rear surface of the second module, the hinge unit being coupled to the hinge coupling portion.

The hinge unit may include a hinge body coupled to the hinge coupling portion, a rotating shaft configured to assist the first module in pivotally rotating about one side thereof, and an L-shaped hinge protruding from the hinge body and connected to the rotating shaft.

The clothes treatment apparatus may further include a door seating flange configured such that at least a portion of the door assembly is seated in the door seating flange, and the hinge coupling portion may be provided at the door seating flange.

The opening may be open or closed by the first module.

The second module may have an annular shape defining a hollowed region.

One of the first body and the second body may include a plurality of hooks arranged in a circumferential direction thereof, and the other one of the first body and the second body may include hook recesses corresponding to the hooks.

The hinge unit may be provided at one side of the first module, and a grip structure may be provided the other side of the first module to assist opening/closing of the door assembly about the hinge unit.

The first module may include at least one coupling protrusion provided at the rim thereof, and the second module may include at least one coupling recess corresponding to the coupling protrusion.

The coupling protrusion may include a sensing piece protruding toward a rear surface of the door assembly to sense whether or not the opening is open or closed.

The second module may further have a seating portion indented such that at least a portion of the outer periphery of the first module is seated in the seating portion.

A radius of the seating portion may be less than a radius of a centrifugally outer surface of the second module.

The seating portion may be formed in the rear surface of the second module.

A radius of the first module may be less than a radius of the second module.

The first module may further have a glass cover configured to support the door glass.

The glass cover may include a first glass cover and a second glass cover to support front and rear surfaces of the door glass respectively.

The glass cover may include a cover body, at least a portion of which is seated in a seating portion indented around the hollowed region of the first module so as to be seated in the first module, and a glass fixing portion extending from the cover body to support the door glass.

In accordance with another aspect of the invention, a door assembly to open or close an opening of a clothes treatment apparatus for insertion or removal of laundry, includes an inner door having a door glass to enable viewing of the interior of the clothes treatment apparatus through the opening, and an outer door having an annular body defining a hollowed region, a seating portion indented in the body around the hollowed region for coupling of the outer periphery of the inner door, and a hinge unit coupled to the periphery of the opening, wherein a position of the hinge unit is changeable to assist the outer door in selectively pivoting about the hinge unit in different directions.

The inner door may include at least one coupling protrusion provided at the rim thereof, and the outer door may include at least one coupling recess corresponding to the at least one coupling protrusion.

The outer door may further have a seating portion indented such that at least a portion of the outer periphery of the inner door is seated in the seating portion.

The seating portion may be formed in a rear surface of the outer door.

A radius of the inner door may be less than a radius of the outer door.

The outer door may have an annular shape defining the hollowed region.

The opening may be open or closed by the outer door.

The door assembly may further include at least two hinge coupling portions formed around the opening at opposite positions for coupling of the hinge unit, and the hinge unit may be selectively coupled to one of the at least two hinge coupling portions.

In accordance with another aspect of the disclosure, a clothes treatment apparatus includes a cabinet having an opening, a drum placed within the cabinet to accommodate laundry therein, the drum being rotated upon receiving rotation power from a drive source, and a door assembly configured to open or close the opening for insertion/removal of the laundry into or from the drum, wherein the door assembly includes an outer door having a hinge unit fixed between a first body defining a front surface having a hollowed region and a second body defining a rear surface, the hinge unit being coupled to the periphery of the opening, a seating portion indented in the rear surface of the second body around the hollowed region, and a pair of upper and lower coupling recesses formed at an outer circumferential surface of the seating portion, and an inner door having a pair of coupling protrusions corresponding to the coupling recesses, the outer periphery of the inner door being seated in the seating portion.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a sectional view showing a clothes treatment apparatus, according to an example embodiment of the present disclosure;

FIGS. 2 and 3 are exploded perspective views showing a first module and a second module of a door assembly, according to example embodiments of the present disclosure;

FIG. 4A is an exploded perspective view showing the second module, according to an example embodiment of the present invention;

FIG. 4B is an exploded perspective view showing the first module, according to an example embodiment of the present invention

FIG. 4C is a perspective view showing a hinge unit, according to an example embodiment of the present invention; and

FIGS. 5A, 5B and 5C are views showing an assembly operation for change in the opening/closing direction of the door assembly, according to example embodiments of the present invention.

### DETAILED DESCRIPTION

Reference will now be made in detail to the embodiments, examples of which are illustrated in the accompanying drawings, wherein like reference numerals refer to the like elements throughout. The embodiments are described below to explain the present invention by referring to the figures.

Hereinafter, reference will now be made in detail to the embodiments of the present invention, examples of which are illustrated in the accompanying drawings, wherein like reference numerals refer to like elements throughout.

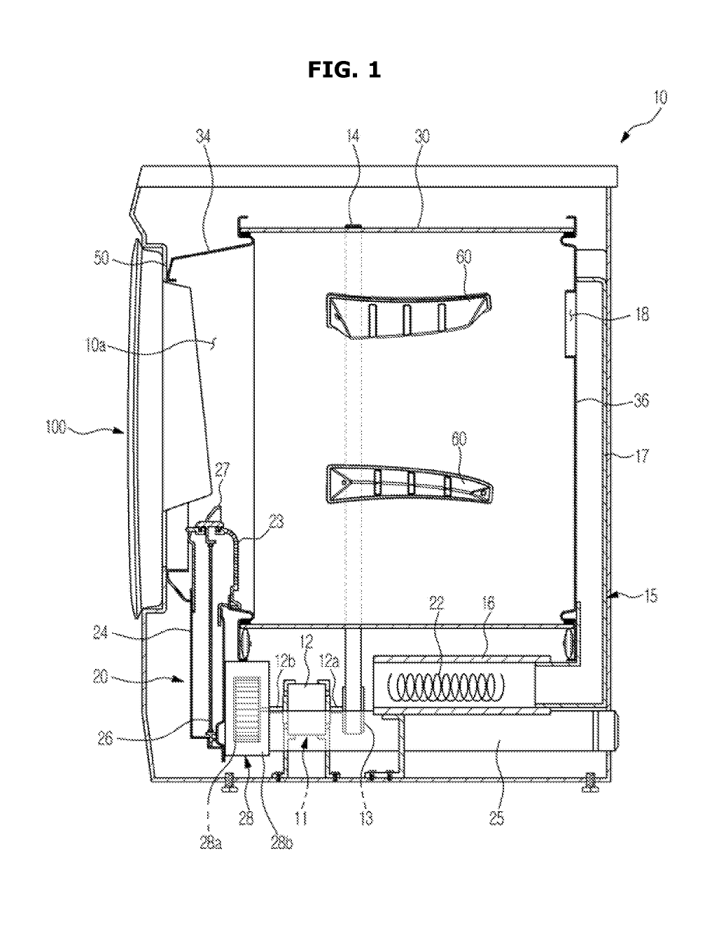

Referring to FIG. 1, a clothes treatment apparatus according to an example embodiment of the present invention may include a cabinet 10 defining an external appearance of the clothes treatment apparatus, a drum 30 rotatably installed inside the cabinet 10, a drive device 11 to rotate the drum 30, and a suction path 15, an exhaust path 20 and a blowing device 28 for air circulation inside the drum 30.

The drum 30 may be a cylindrical drum having open front and rear ends. A plurality of lifters 60 protrudes, in the form of ridges, from an inner surface of the drum 30 to raise and drop an object to be dried. A front support plate 34 and a rear support plate 36 are respectively installed inside a front surface and a rear surface of the cabinet 10. The front support plate 34 and the rear support plate 36 are configured to cover the open front and rear ends of the drum 30 respectively and serve to rotatably support the open front and rear ends of the drum 30.

An opening 10a may be perforated in the front surface of the cabinet 10 and the front support plate 34, such that the object to be dried is inserted into or removed from the drum 30 through the opening 10a. To open or close the opening 10a, a door assembly 100 may be installed to the front surface of the cabinet 10.

The drive device 11 may include a drive motor 12 installed in a bottom region of the cabinet 10, and a pulley 13 and a rotating belt 14 to transmit power of the drive motor 12 to the drum 30. The rotating belt 14 may be wound on an outer surface of the drum 30 and the pulley 13 coupled to a shaft 12a of the drive motor 12.

The suction path 15 may serve to guide introduction of outside air into the drum 30. The suction path 15 may include a lower suction duct 16 installed below the drum 30, a suction port 18 perforated in an upper portion of the rear support plate 36, and a rear suction duct 17 connecting the suction port 18 and the lower suction duct 16 to each other. A heater member 22 may be installed in the lower suction duct 16 and may serve to heat the suctioned air.

The exhaust path 20 may serve to guide discharge of air inside the drum 30. The exhaust path 20 includes an exhaust port 23 perforated in a lower portion of the front support plate 34, a front exhaust duct 24 connecting the exhaust port 23 and an entrance of the blowing device 28 installed below the drum 30 to each other, and a rear exhaust duct 25 installed in the bottom region of the cabinet 10 to communicate an exit of the blowing device 28 with the outside of the rear surface of the cabinet 10.

A filter member 26 is installed to the front exhaust duct 24 and serves to filter foreign substances, such as dust, lint, etc., contained in hot air discharged from the drum 30. The filter member 26 is provided at the top thereof with a grip 27 to assist a user in easily attaching or detaching the filter member 26 to or from the front exhaust duct 24.

The blowing device 28 may include a blowing fan 28a installed to a shaft 12b of the drive motor 12 opposite to the shaft 12b of the drive motor 12 that drives the drum 30, and a blowing case 28b configured to enclose the blowing fan 28a, the blowing case 28b being connected to both the front exhaust duct 24 and the rear exhaust duct 25.

Upon implementation of a typical clothes drying operation using the above-described configuration, a drying object placed in the drum 30 is raised and dropped as the drum 30 is rotated by the drive motor 12 and, simultaneously, outside air is circulated into the drum 30, which ensures rapid drying of the object inside the drum 30.

Air blowing is implemented in such a manner that wet air inside the drum 30 is discharged outward through the exhaust path 20, and as much new air as the discharged air is introduced into the drum 30 through the suction path 15. The air suctioned through the suction path 15 is introduced into the drum 30 after being heated by the heater member 22, which facilitates rapid drying of the object.

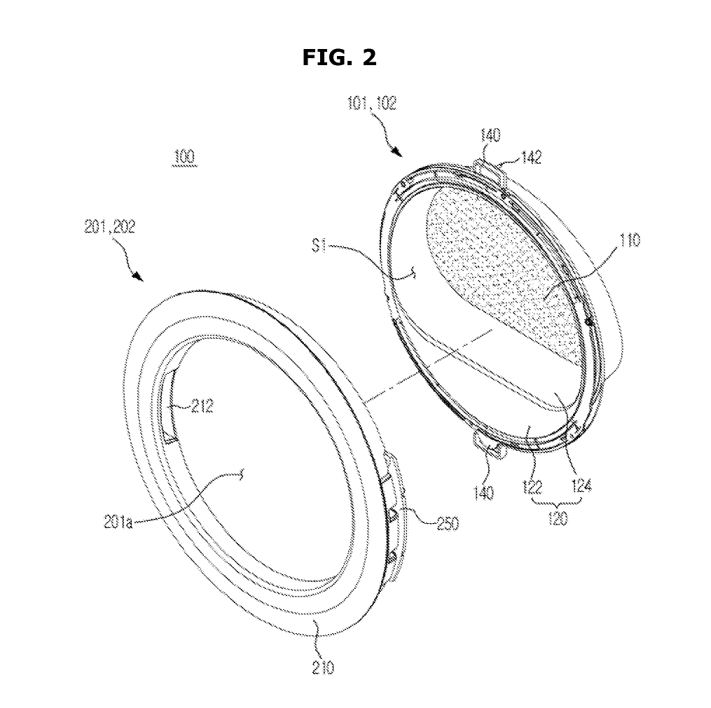

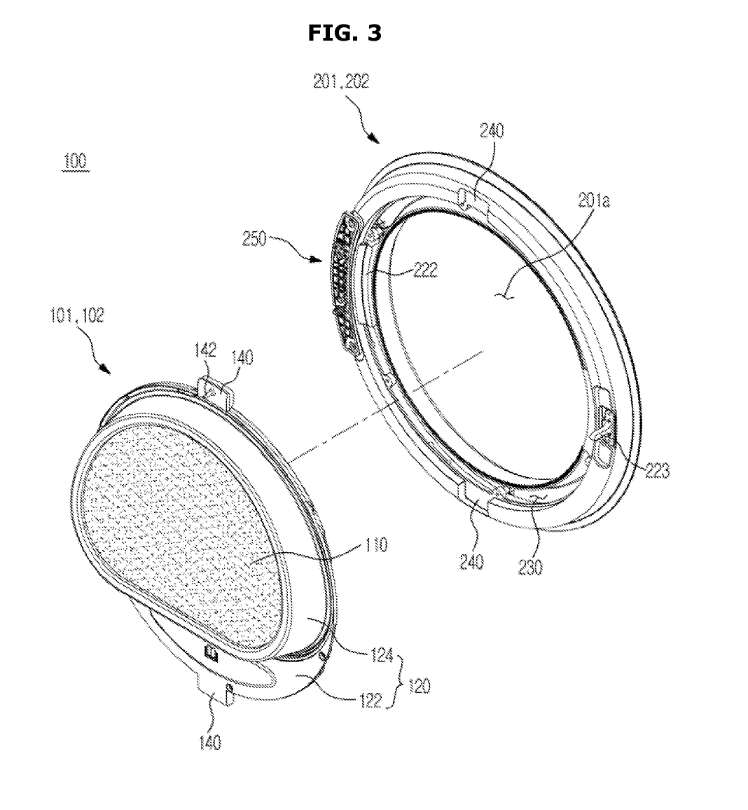

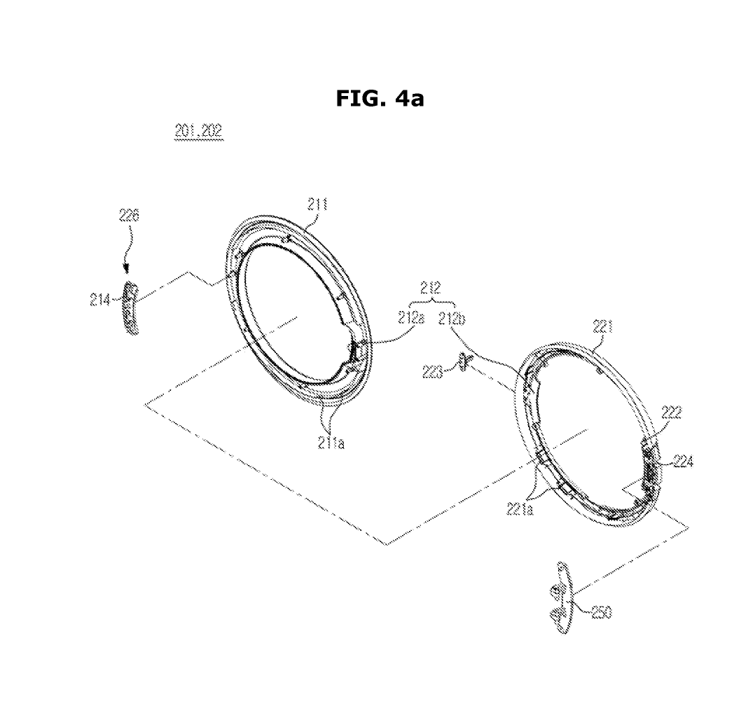

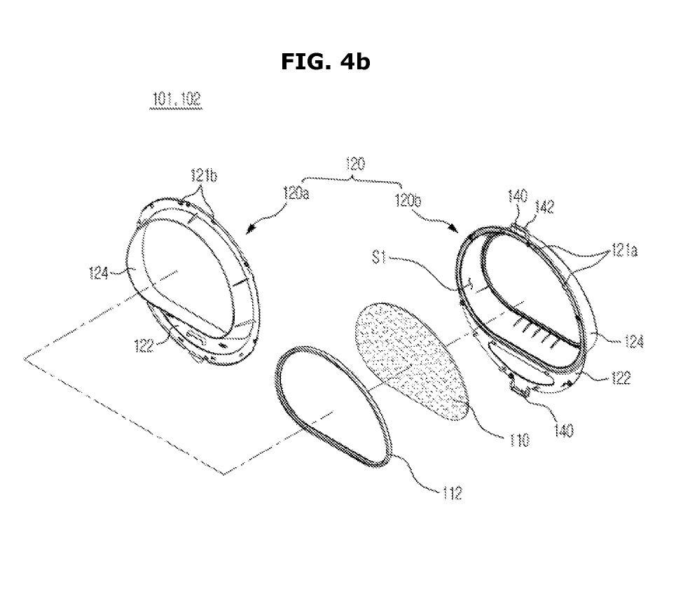

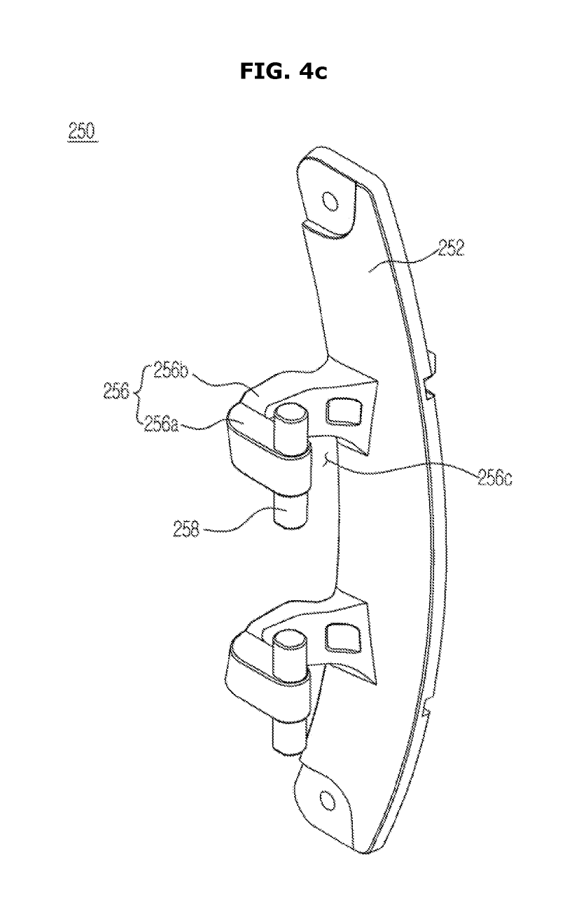

FIGS. 2 and 3 are exploded perspective views showing a first module and a second module of the door assembly, according to example embodiments of the present invention. FIGS. 4A and 4B are exploded perspective views showing the first module and the second module according to example embodiments of the present invention, and FIG. 4C is a perspective view showing a hinge unit according to an example embodiment of the present invention.

The door assembly 100, as mentioned above, may be provided to open or close the opening 10a. The door assembly 100 may include a first module 101 and a second module 201.

The second module 201 is configured to change a position of a hinge unit 250 via rotation thereof so as be selectively opened or closed in different directions.

The second module 201 may have an annular shape to define a hollowed region 201a. The second module 201 may include a second module body 210 and the hinge unit 250.

The second module body 210 may have an annular shape and may include a first body 211 and a second body 221 (shown in FIG. 4a) that respectively define a front surface and a rear surface of the second module body 210. The first body 211 is exposed to the outside when the door assembly 100 closes the opening 10a. The second body 221 is coupled to a rear surface of the first body 211. The second body 221 may have coupling recesses 240 for coupling with the first module 101 that will be described hereinafter. The hinge unit 250 may be interposed between and coupled to the first body 211 and the second body 221 to realize a single modular configuration.

Alternatively, the first body 211 and the second body 221 may be screwed to each other. In another example embodiment, any one body may be provided with a plurality of hooks 211a at an inner circumferential surface thereof, and the other body may be provided with a plurality of hook recesses 221a corresponding to the hooks 211a. The first body 211 and the second body 221 may be coupled to each other via engagement of the hooks 211a and the hook recesses 221a.

The hinge unit 250 that will be described hereinafter may be coupled to one side of the second module body 210 to enable pivoting of the second module body 210. A grip structure 212 may be provided at the other side of the second module body 210 to assist the user in opening or closing the door assembly 100 from or to the opening 10a.

The grip structure 212 may have various shapes suitable for opening/closing of the door assembly 100. For example, the grip structure 212 may include an indentation 212a formed in the periphery of the hollowed region 201a of the annular first body 211 and a grip plate 212b formed at the second body 221 to come into contact with one end of the indentation 212a. However, the indentation 212a and the grip plate 212b are exemplary, and thus, the present disclosure is not limited thereto.

The hinge unit 250 that will be described hereinafter may be coupled to one side of the second module body 210 to enable pivoting of the second module body 210. To provisionally fix the other side of the second module body 210 when the door assembly 100 closes the opening 10a, a fixing member 223 protrudes from the rear surface of the second module body 210 at an opposite side of the hinge unit, i.e. at the other side of the second module body 210. The cabinet 10 has a door seating flange 50 defining an outer peripheral portion of the opening 10a. The door seating flange 50 is provided with an insertion block 60 corresponding to the fixing protrusion 223, such that the fixing protrusion 223 is inserted into the insertion block 60. For coupling of the hinge unit 250 or the insertion block 60, the cabinet 10 may have at least two hinge coupling portions 52 such that the hinge unit 250 is coupled to any one of the hinge coupling portions 52 and the insertion block 60 is coupled to the other hinge coupling portion 52.

The hinge unit 250 may have various shapes so long as it connects the second module body 210 to one side of the opening 10a. Thereby, the second module body 210 may pivot about the hinge unit 250 to open or close the opening 10a. For example, the hinge unit 250 is provided at one side of the second module 201 to couple the second module 201 to one side of the opening 10a and assist the second module 201 in pivoting about one side of the opening 10a. As exemplarily shown in FIG. 4C, the hinge unit 250 may include a hinge body 252 coupled to the cabinet 10 at the periphery of the opening 10a, a rotating shaft 258 rotatably supported by the second module body 210, and an L-shaped hinge 256 connecting the hinge body 252 and the rotating shaft 258 to each other.

The at least two hinge coupling portions 52 are located at the periphery of the opening 10a such that the hinge unit 250 of the second module 201 is coupled to one of the hinge coupling portions 52. Provision of the at least two hinge coupling portions allows the user to conveniently change a position of the hinge unit 250 by rotating the second module 201, which enables change in the opening/closing direction of the door assembly 100.

The hinge body 252 may be coupled to any one of the at least two hinge coupling portions 52. The hinge body 252 may have the same shape as at least a part of the periphery of the opening 10a. For example, the opening 10a has a circular shape, and therefore the hinge body 252 has an arc shape equal to the shape of a partial periphery of the circular opening 10a.

The hinge body 252 may be provided at a rear surface thereof with a holding boss (not shown) to provisionally fix the hinge body 252 to the hinge coupling portion 52. The holding boss may be fixed to a portion of the cabinet 10, i.e. to the periphery of the opening 10a via screwing.

The rotating shaft 258 is located between the first body 211 and the second body 221 and functions as a pivot shaft of the second module body 210. More specifically, the first body 211 has a first rotating-shaft seating portion 214 and the second body 221 has a second rotating-shaft seating portion 224, such that the rotating shaft 258 is seated in the first rotating-shaft seating portion 214 and the second rotating-shaft seating portion 224 as the first body 211 and the second body 221 are coupled to each other. In this way, the rotating shaft 258 may be pivotally supported. In addition, for example, the first rotating-shaft seating portion 214 is defined in a support plate 226 located inside the first body 211 to achieve enhanced durability.

The L-shaped hinge 256 extends from the hinge body 252. The L-shaped hinge 256 may include an inner extension 256a, which extends from the rotating shaft 258 inward of the second module body 210, and a rear extension 256b orthogonally extending from one end of the inner extension 256a to thereby be connected to the hinge body 252. The L-shaped hinge 256 may define a space 256c between the rotating shaft 258 and the hinge body 252.

The space 256c defined by the plurality of extensions defining the L-shaped hinge 256 serves to increase an opening range of the second module body 210 when the second module body 210 pivotally rotates about the hinge unit 250.

The second body 221 may have a reinforcement rib 222 at an inner periphery thereof near the hinge unit 250. The reinforcement rib 222 may compensate for reduction in the thickness of a material due to the presence of the hinge unit 250, thereby achieving enhanced durability.

A seating portion 230 for the first module 101 may be formed in one surface of the second module 201. More specifically, the seating portion 230 may be indented in a rear surface of the second module 201, i.e. in the second body 221 of the second module 201 such that the first module 101 is seated in the second body 221.

The seating portion 230 may take the form of an annular groove such that at least a part of the first module 101 is seated in the seating portion 230. That is, the seating portion 230 may be indented in the body of the second module 201 around the hollowed region 201a.

A radius of the seating portion 230 may be less than a radius of a centrifugally outer surface of the second module 201, and a depth of the seating portion 230 may be less than an axial thickness of the second module 201.

More specifically, assuming that a radius of a centrifugally inner surface of the second module 201 is a first radius and a radius of the centrifugally outer surface is a second radius, the seating portion 230 may be indented starting from the first radius to a position between the first radius and the second radius.

The first module 101 may be seated in the seating portion 230 to thereby be coupled to the second module 201. To achieve stronger coupling, the first module 101 may be screwed to the second module 201. Moreover, the first module 101 may have coupling protrusions 140 to be firmly inserted into the respective coupling recesses 240 of the second module 201.

The first module 101 is configured to hermetically seal the hollowed region 201a of the second module 201 and maintains the same orientation regardless of rotation of the second module 201. The first module 101 may not be coupled to the cabinet and may be coupled to the second module 201 at the opening 10a.

More specifically, the second module 201 performs opening/closing motion of the door assembly 100, and the first module 101 hermetically seals the hollowed region 201a of the second module 201 without participating in the opening/closing motion of the second module 201.

Accordingly, only the second module 201 is rotated to control the opening/closing direction of the door assembly 100. Further, the first module 101 is separated from the second module 201 for rotation of the second module 201 and then again coupled to the second module 201. As such, easy change in the opening/closing direction of the door assembly 100 is possible.

The first module 101 may include a door glass 110. The door glass 110 serves not only to hermetically seal the hollowed region 201a, but also to allow the user to view the interior of the clothes treatment apparatus.

Although the door glass 110 is not limited as to the arrangement or size thereof, in the present embodiment, the door glass 110 may be tilted by a predetermined angle from a virtual plane orthogonal to the center axis of the hollowed region 201a of the second module 201.

Since the second module 201 and the first module 101 having the door glass 110 may be separably coupled to each other, the first module 101 may maintain the same orientation unlike the second module 201 even if the second module 201 is differently oriented to change the opening/closing direction of the door assembly 100. More specifically, the opening/closing direction may be changed without changing the orientation of the door glass 110.

A glass sealing member 112 may be provided at the periphery of the door glass 110 to protect the door glass 110 and prevent leakage of water.

The first module 101 may include a glass cover 120 to support the door glass 110. The glass cover 120 to support the door glass 110 may be seated in a portion of the second module 201 such that the hollowed region 201a of the second module 201 is hermetically sealed by both the glass cover 120 and the door glass 110.

The glass cover 120 may include a plate-shaped cover body 122, and a glass fixing portion 124 extending rearward from the cover body 122 to support the door glass 110.

The cover body 122 may take the form of a plate suitable to come into close contact with the rear surface of the second module 201, and may be configured to hermetically seal the hollowed region 201a of the second module 201.

The glass fixing portion 124 extends from the cover body 122 to support the periphery of the door glass 110. As the glass fixing portion 124, the cover body 122, and the door glass 110 cooperate with one another to hermetically seal the hollowed region 201a of the second module 201, leakage of water is prevented.

Alternatively, the cover body 122, which takes the form of a plate, may have a hole for positioning of the door glass 110. The glass fixing portion 124, which extends from the cover body 122 to support the door glass 110, may have an inner space S1 defined between the cover body 122 and the glass fixing portion 124 so as to communicate with the hole.

The coupling recesses 240 for coupling of the first module 101 may be arranged around the hollowed region 201a of the second module 201. The coupling protrusions 140 may be formed at the rim of the cover body 122 of the first module 101 to fix the first module 101 to the second module 201. To allow the first module 101 to be coupled to the second module 201 without changing an orientation thereof even if a position of the hinge unit 250 of the second module 201 is changed, at least two coupling recesses 240 and at least two coupling protrusions 140 may be provided.

For example, the opening/closing direction of the door assembly 100 is changeable within a range of 180 degrees. Although two coupling protrusions 140 or two coupling recesses 240 may be symmetrically arranged in the present embodiment, a greater number of coupling protrusions or coupling recesses may be provided in consideration of the opening/closing direction of the door assembly 100. Accordingly, the first module 101 may maintain the same orientation even if a position of the hinge unit 250 of the second module 201 is changed as needed.

Any one of the plurality of coupling protrusions 140 may be provided at a rear surface thereof with a sensing piece 142. The sensing piece 142 may be inserted into a sensing recess (not shown) formed in the cabinet 10 to detect opening or closing of the door assembly 100.

The glass cover 120 may include a first glass cover 120a and a second glass cover 120b.

The glass fixing portion 124 of the first glass cover 120a and the glass fixing portion 124 of the second glass cover 120b respectively support a front surface and a rear surface of the rim of the door glass 110 to support the door glass 110. More specifically, the glass fixing portion 124 functions to support the glass sealing member 112 surrounding the door glass 110, in addition to preventing leakage of water.

In addition, the cover body 122 of the first glass cover 120a and the cover body 122 of the second glass cover 120b may be screwed to each other, but may be coupled to each other using the hooks 121a and the hook recesses 121b as in the present embodiment. This hook engagement ensures easy coupling.

The coupling protrusions 140 may be provided at any one of the first glass cover 120a and the second glass cover 120b. In the present embodiment, the coupling protrusions 140 are provided at the rim of the second glass cover 120b.

Alternatively, the first module 101 may be referred to as an inner door 102 having the door glass 110 to allow the user to view the interior of the clothes treatment apparatus through the opening 10a, and the second module 201 may be referred to as an outer door 202 coupled to the outer periphery of the inner door 102 and provided with the hinge unit 250 coupled to the opening 10a. For example, a position of the hinge unit 250 is changeable to allow the outer door 202 to pivotally rotate about the hinge unit 250.

In an example embodiment, the inner door 102 may be provided with the coupling protrusions 140 and the outer door 202 may be provided with the coupling recesses 240, such that the inner door 102 is coupled to the outer door 202 regardless of the opening/closing direction of the outer door 202. However, the present disclosure is not limited thereto.

With regard to the door assembly 100 having the above-described configuration and the clothes treatment apparatus having the door assembly 100, change in an opening/closing direction of the door will hereinafter be described.

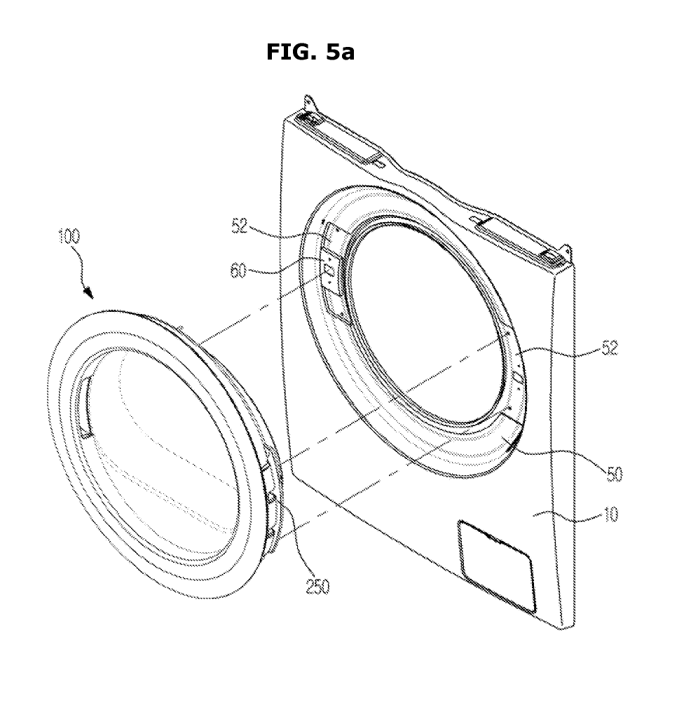

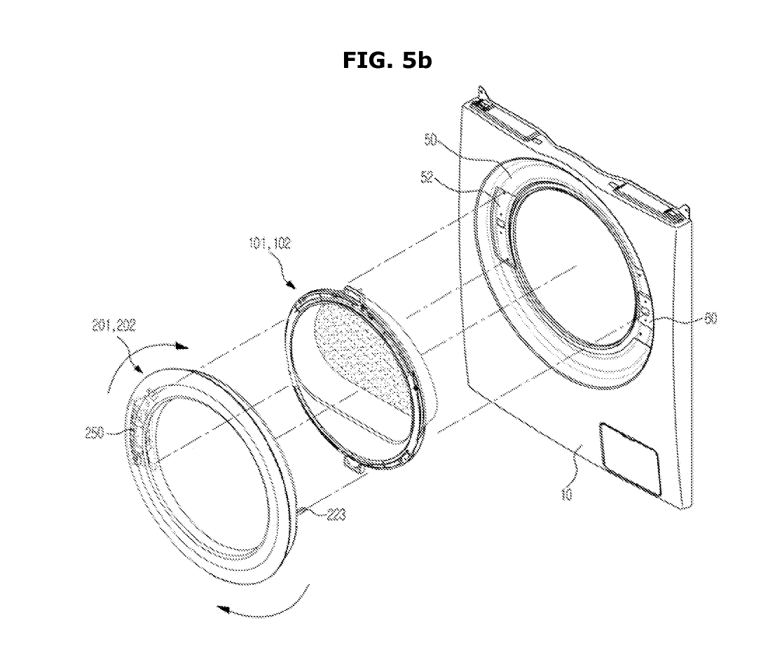

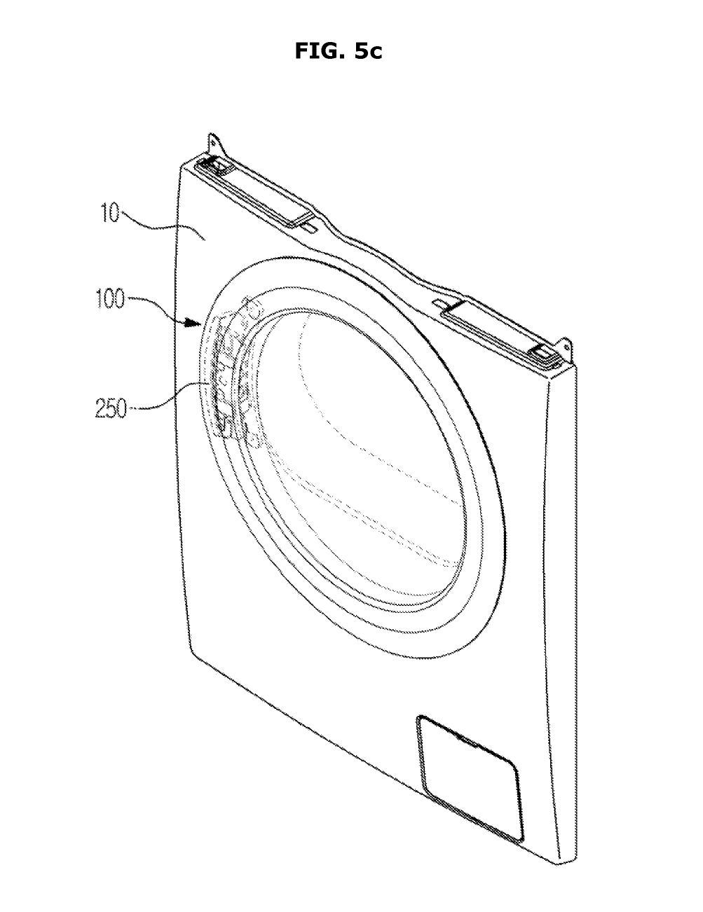

As exemplarily shown in FIG. 5A, the hinge unit 250 is provided at one side of the door assembly 100 such that the door assembly 100 opens or closes the opening 10a via pivotal rotation thereof.

As exemplarily shown in FIG. 5B, to change a position of the hinge unit 250 that is the pivot center of the door assembly 100, first, a specific part of the hinge unit 250 connected to the cabinet 10 is disassembled, and thereafter the second module 201 is rotated to move the hinge unit 250 at a position selected by the user.

After the second module 201 is disassembled from the first module 101, the first module 101 is reassembled to the second module 201 to maintain the same orientation as that before rotation of the second module 201.

As exemplarily shown in FIG. 5C, the opening/closing direction of the door assembly 100 is completely changed when the hinge unit 250 of the second module 201 is fixed at the selected position.

Conventionally, since changing a position of a hinge as a pivot center is impossible, it is necessary to change the orientation of the clothes treatment apparatus according to the opening/closing direction of the door. Moreover, even if a position of a hinge is changeable, it is necessary to disassemble and reassemble all components of the door and the cabinet. However, according to the present embodiment, the door assembly 100 has a modular configuration such that an opening/closing direction thereof may be changed via simplified reassembly.

As is apparent from the above description, a clothes treatment apparatus according to the embodiment of the present invention includes a modular door, an opening/closing direction of which is easily changeable, which may reduce the number of components, resulting in reduced fabrication time and easier assembly.

Although the drawings and disclosure have shown and discussed a door assembly for a clothes treatment apparatus, the present disclosure is not limited to a door assembly of a home appliance. In addition, although the drawings illustrate an annular shape of a body of the door assembly, the present disclosure is not limited thereto.

Although the embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A clothes treatment apparatus, comprising:
a cabinet having an opening;
a drum placed within the cabinet, the drum being rotated upon receiving rotation power from a drive source;
a door assembly configured to open or close the opening; and
a hinge coupling portion formed around the opening, to which one side of the door assembly is hingedly coupled,
wherein the door assembly includes:
a first module having a door glass; and
a second module separably coupled to the first module, the second module comprising a hinge unit fixed between a first body and a second body that respectively define a front surface and a rear surface of the second module, the hinge unit being coupled to the hinge coupling portion.

2. The apparatus according to claim 1, wherein the drum accommodates laundry therein, and the door assembly is configured to open or close the opening for insertion/removal of the laundry into or from the drum.

3. The apparatus according to claim 1, wherein the hinge unit comprises:
a hinge body coupled to the hinge coupling portion;
a rotating shaft configured to assist the first module in pivotally rotating about one side thereof; and
an L-shaped hinge protruding from the hinge body and connected to the rotating shaft.

4. The apparatus according to claim 1, further comprising a door seating flange configured such that at least a portion of the door assembly is seated in the door seating flange,
wherein the hinge coupling portion is provided at the door seating flange.

5. The apparatus according to claim 1, wherein the opening is open or closed by the first module.

6. The apparatus according to claim 1, wherein the second module has an annular shape defining a hollowed region.

7. The apparatus according to claim 1, wherein one of the first body and the second body comprises a plurality of hooks arranged in a circumferential direction thereof, and
wherein the other one of the first body and the second body comprises hook recesses corresponding to the hooks.

8. The apparatus according to claim 1, wherein the hinge unit is disposed at one side of the first module, and a grip structure is disposed at the other side of the first module to assist opening/closing of the door assembly about the hinge unit.

9. The apparatus according to claim 1, wherein the first module comprises at least one coupling protrusion disposed at the rim thereof, and
wherein the second module includes at least one coupling recess corresponding to the coupling protrusion.

10. The apparatus according to claim 9, wherein the coupling protrusion comprises a sensing piece protruding toward a rear surface of the door assembly to sense whether or not the opening is open or closed.

11. The apparatus according to claim 1, wherein the second module further comprises a seating portion indented such that at least a portion of the outer periphery of the first module is seated in the seating portion.

12. The apparatus according to claim 11, wherein a radius of the seating portion is less than a radius of a centrifugally outer surface of the second module.

13. The apparatus according to claim 11, wherein the seating portion is formed in the rear surface of the second module.

14. The apparatus according to claim 1, wherein a radius of the first module is less than a radius of the second module.

15. The apparatus according to claim 1, wherein the first module further comprises a glass cover configured to support the door glass.

16. The apparatus according to claim 15, wherein the glass cover comprises a first glass cover and a second glass cover to support front and rear surfaces of the door glass, respectively.

17. The apparatus according to claim 15, wherein the glass cover comprises:
a cover body, at least a portion of which is seated in a seating portion indented around the hollowed region of the first module so as to be seated in the first module; and
a glass fixing portion extending from the cover body to support the door glass.

18. A door assembly to open or close an opening of a clothes treatment apparatus for insertion or removal of laundry, the door assembly comprising:
an inner door comprising a door glass to enable viewing of the interior of the clothes treatment apparatus through the opening; and
an outer door comprising an annular body defining a hollowed region, a seating portion indented in the body around the hollowed region for coupling of an outer periphery of the inner door, and a hinge unit coupled to the periphery of the opening,
wherein a position of the hinge unit is changeable to assist the outer door in selectively pivoting about the hinge unit in different directions.

19. The door assembly according to claim 18, wherein the inner door comprises at least one coupling protrusion disposed at the rim thereof, and
wherein the outer door comprises at least one coupling recess corresponding to the at least one coupling protrusion.

20. The door assembly according to claim 18, wherein the outer door further comprises a seating portion indented such that at least a portion of the outer periphery of the inner door is seated in the seating portion.

21. The door assembly according to claim 20, wherein the seating portion is formed in a rear surface of the outer door.

22. The door assembly according to claim 18, wherein a radius of the inner door is less than a radius of the outer door.

23. The door assembly according to claim 18, wherein the outer door has an annular shape defining the hollowed region.

24. The door assembly according to claim 18, wherein the opening is open or closed by the outer door.

25. The door assembly according to claim 18, further comprising at least two hinge coupling portions formed around the opening at opposite positions for coupling of the hinge unit,
wherein the hinge unit is selectively coupled to one of the at least two hinge coupling portions.

26. A clothes treatment apparatus comprising:
a cabinet having an opening;
a drum placed within the cabinet to accommodate laundry therein, the drum being rotated upon receiving rotation power from a drive source; and
a door assembly configured to open or close the opening for insertion/removal of the laundry into or from the drum,
wherein the door assembly comprises:
an outer door comprising a hinge unit fixed between a first body defining a front surface having a hollowed region and a second body defining a rear surface, the hinge unit being coupled to the periphery of the opening, a seating portion indented in the rear surface of the second body around the hollowed region, and a pair of upper and lower coupling recesses formed at an outer circumferential surface of the seating portion; and
an inner door having a pair of coupling protrusions corresponding to the coupling recesses, the outer periphery of the inner door being seated in the seating portion.

27. A door assembly, comprising:
a first module having an upper side and a lower side that are asymmetrical to each other; and
a second module having a hinge unit, such that the second module is configured to change a position of the hinge unit via rotation thereof so as to be selectively opened or closed in different directions.
